(19) United States
(12) Patent Application Publication
(10) Pub. No.: US 2025/0058975 A1
(43) Pub. Date: Feb. 20, 2025

(54) CORE LOGGING TRACK TILT ADAPTER AND METHOD OF USE

(71) Applicant: Dynamics G-Ex Pty Ltd, Gympie (AU)

(72) Inventors: John Hitch, Mundaring (AU); Travis Dormer, Jones Hill (AU)

(21) Appl. No.: 18/808,542

(22) Filed: Aug. 19, 2024

(30) Foreign Application Priority Data
Aug. 18, 2023 (AU) 2023902626

(51) Int. Cl. B65G 13/08

(52) U.S. Cl. CPC B65G 13/08; B65G 2201/0258

(57) ABSTRACT

A drill core logging table assembly comprises a core logging table having a section of laterally inclined roller track defining a plane on which a core tray is supportable for logging, and a roller track adapter that includes a section of roller track having a first end for aligning with the laterally inclined roller track of the table, and a second end that is horizontally disposed for aligning and connecting with a section of horizontally disposed roller track to provide a contiguous path along which a core tray can be conveyed between the horizontal and inclined plane. The invention extends to a method of core logging utilizing the table assembly and the adapter.

### CROSS-REFERENCE TO RELATED APPLICATIONS

This application claims the benefit of Australian Patent Application No. 2023902626, filed on Aug. 18, 2023. The entire disclosure of the above application is incorporated herein by reference.

### TECHNICAL FIELD

This disclosure relates to a drill core logging facility and apparatus and a method for enabling placement of a core tray on a laterally inclined logging table for contents inspection and core logging in particular, by causing a change in its orientation.

### BACKGROUND TO THE DISCLOSURE

Core trays are used in the mining and exploration industry to store and transport mineral core samples obtained from drilling operations. Core trays are typically made of plastic, metal, wood or cardboard and have different sizes and shapes depending on the type of core sample. Generally, a core tray will have a plurality of core-receiving and retention channels extending longitudinally in parallel from end to end of the tray. Core trays are often stacked on pallets or similar hard stand areas for storage or transport.

Core tray logging is a process involving examining, measuring, describing, and recording the features and characteristics of the core samples in a core tray. Core tray logging is usually performed in a dedicated room or facility that has adequate lighting, ventilation, and equipment for inspecting and analysing the core samples. Core tray logging is an important step in mineral exploration and resource estimation, as it provides valuable information about the geology, mineralogy, structure, and quality of the ore body from which the sample has been obtained.

One of the challenges in core tray logging is to move the core trays from the storage or transport area to the inspection or logging station, where the core samples are examined by a geologist or technician. Typical drill-core samples are coherent elongate solid cylindrical lengths of rock liberated from a mineral body by a core drill. However, samples placed in a core tray may be composed of a mineral fragments. Single-piece core samples, with a circular cross-section, tend to measure about 800 mm to 1200 mm in length and about 55 mm to 75 mm in diameter, from which it will be appreciated that they have considerable weight. A tray loaded with 6 such samples is challenging to move by hand and presents a lifting challenge, even to the human adult of bigger-than-average build. Moreover, in many mines and mining exploration workplaces, a loaded tray, because of its weight, is considered a manual handling issue, requiring a two-person lift and an increased human resource presence for operations to proceed.

Conventional methods of moving core trays may involve manual lifting (usually by two or more persons), pushing, or pulling of the core trays. These activities can be labour-intensive, time-consuming, and prone to errors or accidents resulting in injury to personnel or fragmentation of cores. Automated or semi-automated systems are known and these may entail the use of conveyors, rollers, or other mechanisms to move the core trays along a predetermined path. These systems may, however, be complex, costly, or inflexible to accommodate different sizes and shapes of core trays. Manual handling it better able to adapt to these physical tray variables.

Roller conveyors are known, in which a plurality of rollers is rotatably mounted side by side in spaced relationship between parallel rails. The rotational axes of the rollers are generally parallel to each other and lie in a common horizontal plane, to define a roller track along which a core tray can travel, so that a core tray, when placed on the rollers forming the track, can be pushed or pulled along the track from one roller to the next, thereby to travel from a first location to a second along said track. Should the track include a curved section, the rotational axes of the rollers will not be parallel, but will assume a fan-like divergence from the centre of curvature of the curve.

It is known that to facilitate visual inspection and access to individual core sample contained in a tray, the tray should preferably be inclined towards the viewer, by causing the side of the tray distal from the viewer to be relatively higher than the side proximal to the viewer. In this configuration, the trays are orientated for inspection without necessitating that the viewer should lean out over the tray excessively to view the most distally located core, risking possible musculoskeletal injury. Depending on the angle of inclination and the stature of the viewer, the cores may be presented to the viewer substantially equidistant from the viewer's eyes. An inclined core logging table having a section of roller track along which core-trays are displaceable is available from the Palsatech corporation of Finland (www.palsatech.fi). The angle of lateral inclination of the logging table may reach 40° above the horizontal. FIG. 1 illustrates such a table.

Similar inclined documentation or logging tables are disclosed in Russian utility model publications RU205390U1 and RU205551U1. A difficulty with known fixed systems of this type is that the core-trays need to be manhandled on to the sloping section for inspection and offloaded thereafter for downstream processing, creating drop hazards for personnel and elevating the risk that a core may be fractured, if not fragmented and destroyed, resulting in significant pecuniary loss. These tables are not adjustable by the customer, but are set at a predetermined angle of inclination before sale and installation according to specifications from the customer. To address these risks and difficulties, hydraulic lifting devices are employed. These are relatively expensive, require installation of power supplies, are slow to operate and, crucially, introduce an additional moving step in the process of locating and orienting the core trays for inspection. Moreover, these introduce pinch points which may result in the emergence of workplace health and safety issues.

The angled orientation of prior art systems allows two separate lengths of roller track to be butted up to each other so as to be aligned to provide two parallel tracks, thereby increasing total logging track holding capacity. When double conveyor frames are kept horizontally orientated, the human inspector needs to move around the track system from one side to the other to be able to view the distal tray on the farther track.

US patent application publication number US 2021/0231631A1 describes a stand-alone inspection table for core trays. The table has a surface comprising parallel rollers over which a tray may be rolled sideways towards an inspection position for a human inspector. The table has a mechanical lifting mechanism powered electrically or hydraulically to raise the entire table or optionally raise a distal side to incline the inspection surface towards the inspection position. Furthermore, the table is structurally mounted on wheels or casters, to enable the entire assembly to be moved as required, for example to a loading point. The table is loaded with a tray while horizontally disposed. Once loaded it may be partially inclined.

An alternative way of inclining a logging table is disclosed in a newsletter published by Agnico Eagle Fosterville Community News, 1st Edition 2022, and locatable at the website <https://s3.ap-southeast-2.amazonaws.com/wysiwyg-blog.4pi.com.au/fgm-content/newsletter/fgmcommunitynews1stedition2022-O4CwNgV1cEZRuXN.pdf>. The tray logging table here is shown to be a terminal part of a continuous roller track leading from a horizontally flat portion of roller track. The logging part is at a constant angle of inclination along its length. However, intermediate the inclined table and the flat portion of the track, a portion of the track is gradually elevated and inclined laterally by means of jacking devices placed below and adjacent one lateral edge, which lies opposite the edge at which personnel inspecting the core samples would be positioned. The opposite edge is roughly and conveniently at about waist height of the average human inspector. The angle of inclination achieved in the illustration is estimated to be in the range from about 15°-20°.

Increasing heights or levels of jacking result in the lateral edge distal from an opposite edge being raised to the level required at the terminal logging portion, while the opposite edge remains at the level of the horizontal flat portion. There is no disruption in the continuity of the roller track as it leads from the flat portion to the logging portion. However, this presents a difficulty in that the angle of inclination obtainable does not reach 40° without the opposite edge being lifted over an excessively long length of path leading to the logging portion, the angle of inclination of which is constant. If the roller track is not fully supported over the whole length of its increasing inclination, the track may dip and buckle when a loaded core tray is conveyed upwardly along it en route to the logging portion. This creates a risk of the tray being overturned or capsized and at least most of the sample within being compromised, if not destroyed.

A disadvantage of the continuous roller track with a gradually increasing angle of inclination is that the maximum angle achieved is affected by the space available in the logging room where the track is installed. This is because the greater the elevation and inclination being sought, the longer the run of track that is required to reach such angle. Because of space availability, inclination in excess of 30° is difficult to obtain.

### OBJECT OF THE DISCLOSURE

It is an object of this disclosure to address the shortcomings of the prior art and, in doing so, to provide core tray transporting apparatus for use in a mining or geological exploration environment in which drill cores are able to be inspected at an ergonomically advantageous angle of inclination while making improved use of available space.

A further object of the present disclosure is to provide apparatus for use in changing the orientation of a core tray from horizontal to a desired inclination for case of inspection.

The preceding discussion of the background to the present disclosure is intended to facilitate an understanding thereof. However, it should be appreciated that said discussion is not an acknowledgement or admission that any of the material referred to was part of the common general knowledge in as the art at the priority date of the present application.

Further, and unless the context clearly requires otherwise, throughout the description and the claims, the words ‘comprise’, ‘comprising’, and the like are to be construed in the inclusive sense of “including, but not being limited to”—as opposed to an exclusive or exhaustive sense meaning “including this and nothing else”.

In this specification, the term “laterally inclined” when applied to a roller track section means that the track is tilted at an angle relative to the horizontal plane across or transverse to the direction of rotation of the rollers forming the track, or is tilted with one side rail of the track being at a different elevation than the opposite rail of the track.

### SUMMARY OF DISCLOSURE

This disclosure covers a number of related aspects.

According to a first aspect, there is provided a method of establishing a continuous roller track leading from a first section of roller track to a second section of roller track, the first section being horizontally disposed and the second section being laterally inclined to define a logging table, the method including fitting between said sections a track inclination adapter comprising a length of roller track having a gradually changing lateral inclination that aligns at a first end with the horizontal first section and at an opposite second end with the laterally inclined second section, thereby to form a continuous roller track for travel of a core tray from the horizontal roller track section to the logging table.

The adapter may include a pair of opposed spaced rails, between which a plurality of rollers is rotatably mounted to define a curve in said continuous roller track when viewed from the first or the second end.

In an embodiment, the curving roller track approximates a portion of a helix.

The method may include adjusting the rails in height and angle relative to a horizontal plane.

In a second aspect, the disclosure provides a method of core tray logging including the steps of:
a. providing a logging table having section of roller track orientated at an angle of lateral inclination for facilitating inspection and logging of drill cores in a core tray disposed on the table,
b. providing a track inclination adapter comprising a length of roller track having a gradually changing lateral inclination that at a first end is horizontally disposed, and, at an opposite second end, is laterally inclined for aligning with the section of roller track of the logging table, thereby to form a continuous roller track for travel of a core tray from the horizontal first end to the table,
c. operatively connecting the adapter first end to a section of horizontally disposed roller track and the adapter second end to the section of laterally inclined roller track of the logging table, and
d. propelling a core tray laden with drill cores along the track to the logging table and logging the cores.

The adaptor may include a pair of opposed rails, between which a plurality of rollers is rotatably mounted to define a curving roller track.

In a third aspect of the present disclosure, there is provided a drill core logging table assembly including a core logging table having a section of laterally inclined roller track defining a plane on which a core tray is supportable for logging, and a roller track adapter comprising a section of roller track having a first end for aligning with the laterally inclined roller track of the table, and a second end that is horizontally disposed, configured for aligning with a horizontal roller track section, said roller track adapter section having a continuously and progressively increasing lateral inclination from end to end, whereby a continuous roller track is established for travel of a core tray from the horizontal track section to the table.

In a fourth aspect, a roller track adapter is configured for transitioning from a first roller track section having a horizontal orientation to a drill core logging table on which a second roller track section having a lateral inclination is mounted, so that a laden core tray is transferable by rolling it from the first section to the second, the adapter including a third roller track section having a first end for aligning with the first section and a second end for aligning with the second section, and being operably locatable between and connectable to said first and second sections, the third roller track section having a continuously and progressively increasing lateral inclination from end to end, thereby establishing a continuous roller track along which a core tray may travel from the first track section to the second section.

In a fifth aspect of this disclosure, there is provided a drill core logging facility including a roller track system comprising a roller track that leads continuously from a receiving bay to an inspection station configured for inspection of drill cores in a core tray, wherein the track is configured to support a core tray in a horizontal first plane, and the inspection station is configured to support the tray in a second plane that differs from the first plane by being laterally inclined, wherein the roller track system includes an adapter section insertable to be installed intermediate the receiving bay and the inspection station, the adapter section transitioning the roller track from supporting a tray passing across it in the first plane to supporting it in the second plane, by virtue of including rollers having continuously and progressively changing lateral inclination from a first end of the adapter section coinciding with the first plane, to a second end coinciding with the second plane.

The second plane may correspond to the laterally inclined plane of the track at the inspection station, whereby visual inspection of drill cores on the core tray is facilitated.

### BRIEF DESCRIPTION OF DRAWINGS

In order that the disclosure may be readily understood, and put into practical effect, reference will now be made to the accompanying figures. Thus:

FIG. 1 illustrates a self-standing inclined logging table of the prior art not connected to a feeder track.

FIG. 2 is a schematic perspective view of a portion of an exemplary drill-core logging facility equipped with a roller track system including logging tables according to a preferred embodiment of the present disclosure.

FIG. 3 is a schematic perspective view of a portion of the roller track system of FIG. 2 in operative orientation for visual inspection by a personnel member.

FIG. 4 is a top view of the roller track portion of FIG. 3.

FIG. 5 is a schematic end view of the roller track inspection station showing in profile the inclined portion of the roller track.

FIG. 6 is a diagram illustrating the roller track portion of FIG. 3 inside view from opposite a personnel member inspecting cores in a core tray borne on the track.

FIG. 7 provides schematic (a) side and (b) end views of the roller track of adapter section of FIG. 6.

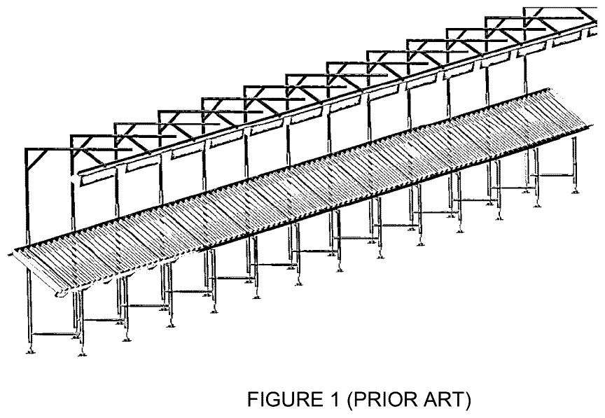

### DETAILED DESCRIPTION OF EXEMPLARY EMBODIMENTS

The following description and drawings are illustrative and are not to be construed as limiting. Numerous specific details are described to provide a thorough understanding of the presently disclosed embodiments. However, in certain instances, well-known or conventional details are not described, in order to avoid obscuring the salient features of solutions disclosed in this description.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments in common, but not by others. Similarly, various requirements are described which may be requirements for some embodiments but not for other embodiments.

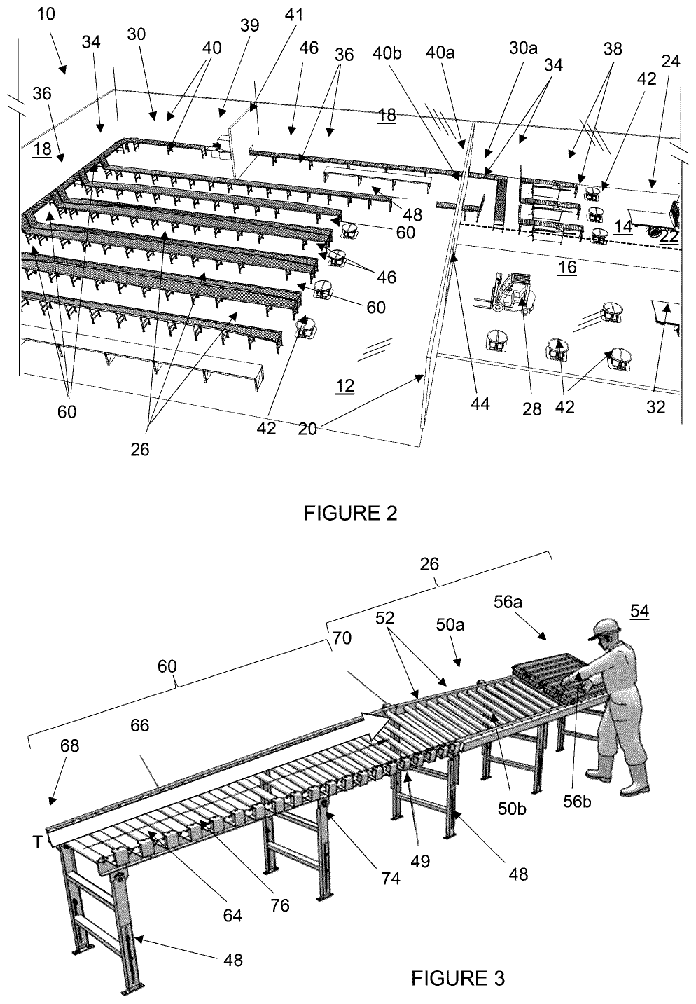

Referring to FIG. 2, the numerical label 10 denotes in general an embodiment of a drill-core logging facility generally shown in schematic perspective view. The facility is shown located in a bounded space, such as in a shed, warehouse or laboratory. However, it may, where circumstances permit, be located in the open air. The exemplary facility here illustrated comprises a core logging room 12, a core tray receiving bay 14 and a core tray dispatch bay 16. These are located within an area defined partially by surrounding upright wall 18. Room 12 is separated from bays 14 and 16 by an upright partition 20. A line 22, marked on the floor of the facility, indicates the boundary between the receiving bay 14 and dispatch bay 16. In other such facilities, the layout will differ and walls may be differently located or omitted partially or altogether. The boundaries between different functional areas may be marked by means other than a line on a floor, or may be omitted. The use of such boundary markings may be governed by local health and safety regulations.

In receiving bay 14, core trays containing core samples (not shown) are offloaded from a delivery vehicle 24 and placed on a conveyor system, generally denoted by the number 30, for moving them to logging tables 26 in room 12. The delivery vehicle is depicted as a truck, but may be any type of suitable conveyance, including a vehicle confined to running on a rail track and an unmanned aerial vehicle, such as a drone.

After logging and any other form of required inspection is completed, the trays are taken to dispatch bay 16 by forklift 28 and loaded on to a removal vehicle 32, which takes them away to a remote storage archive, or otherwise for disposal. Instead of a forklift, a mobile crane, or a stationary lifting device may be utilised.

The conveyor system 30 is made up of sections of roller track, which may be connected or disconnected from each other at various points by bridging pieces 34, which are depicted here in a raised, generally close-to-vertical position. The bridging pieces 34 are pivotally connected at one end to an adjoining track section and are lowerable on to the level of the track section opposite the pivot point, thereby to form a contiguous track. When lowered, the bridging pieces connect different sections of roller track so as to allow routing of core trays to selected logging tables 26. When raised, the bridging pieces permit passage of personnel between different zones in the facility, in cases where the track would otherwise form a barrier to human movement. The rollers of the bridging pieces are generally horizontally disposed.

In the illustrative embodiment of FIG. 2, roller track system 30 includes a plurality of tray receiving beds 38 situated in receiving bay 14 and a pair of main feeder tracks 36 that connect to a number of branch tracks leading off the logging tables 26.

The receiving beds are made up of short sections of roller track in this embodiment, but may in other embodiments have different types of tray supporting beds, for example a rack of horizontal bars, a grid, or a continuous sheet of a suitably robust and wear-resistant material such as a stainless steel. For assistance in transferring the core tray from delivery truck 24 to receiving bed 38, lifting/lowering rigs 42 may be employed, especially when the level of the flat bad of the delivery truck differs from that of the receiving bed. Lifting/lowering rigs may similarly be used when transferring the core trays after core logging from logging tables 26 to forklift 28 and thence to dispatch truck 32.

Once a core tray containing unlogged cores has been placed on a receiving bed 38, and the bed has been connected to feeder track 36 by lowering the relevant bridging piece 34, it may then be propelled by hand to an allocated logging table 26 in room 12. Portals 40a,b are formed in partition 20 to allow continuous passage of feeder track 36 from receiving bay 14 to room 12. In the exemplary embodiment of FIG. 2, a scanner apparatus 39 is positioned behind screen 41. The scanner may be utilised for scanning identification markings on the core trays as they pass along track 36. A doorway 44 enables passage through partition 20 for the forklift and personnel between room 12 and dispatch bay 16.

It will be observed that the logging table sections 26 may comprise double tracks 46, allowing a pair of core trays, located side by side, to be logged together. The logging facility preferably includes a plurality of logging tables. For efficient space utilisation, these are shown arranged in parallel in FIG. 2. Other layouts are of course possible within the scope of this disclosure.

The roller track sections are supported at a convenient height above floor level by a series of paired legs 48 connected by crossbars 49. Adjacent track sections may be jointly supported on a shared set of such legs to which they are connectable. The legs may be adjustable in height to elevate or lower the track using known mechanisms.

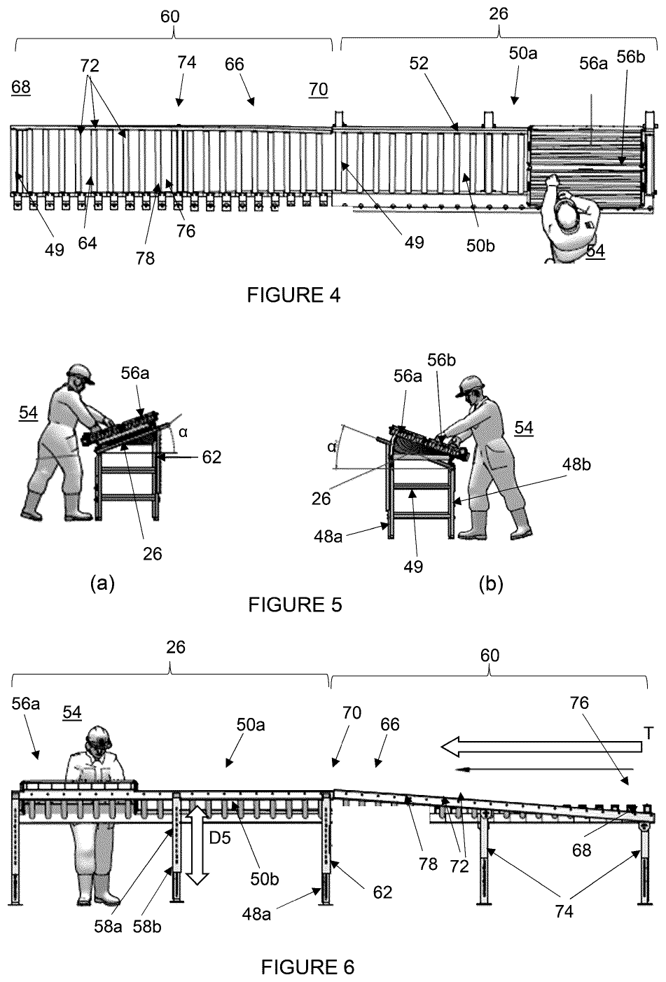

FIGS. 3, 4 and 6, illustrate components of the logging tables 26 and an adjacent transitional track adapter section 60, the function of which will be disclosed further below. Adapter section 60 is shown in FIG. 2 as part of the general layout of a track system in a non-limiting environmental embodiment of a logging facility.

The roller track feeder sections 36 and logging tables 26 each comprise a pair of parallel side rails 50a,b, between which are transversely and rotatably mounted a set of spaced individual rollers 52. The axes of the rollers are coplanar, so that their surfaces provide an imaginary plane on which the lower surfaces of core trays 56a,b may rest or roll, as is known in the art. In the figures, rail 50a is distal and rail 50b proximal in relation to a human operator 54 working on drill cores contained in a pair of core trays 56a,b.

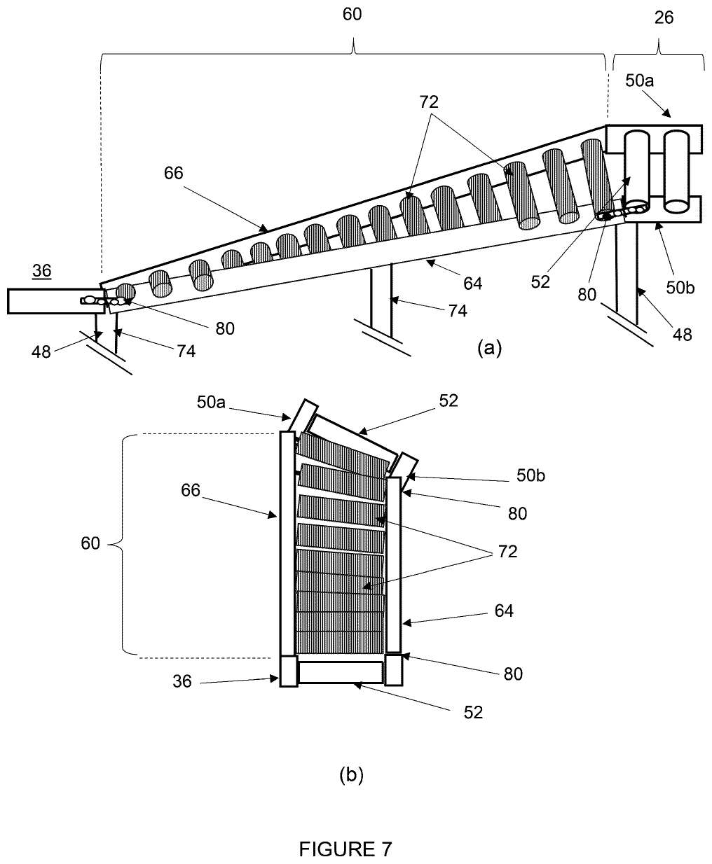

It will be appreciated that feeder track sections 36 and bridging pieces 34 (when arranged in operative lower connecting position) lie generally horizontally, whereas the logging tables 26, as shown in profile in FIG. 5, are laterally inclined to an angle at which logging operator 54 is able conveniently to view and have access to each of the drill cores in the core trays 56a,b before them. As shown in FIG. 6 and FIG. 7, the side rails 50a,b of the sections of track of the logging tables are also laterally inclined from the vertical. The degree of inclination is maintained by virtue of settable pivotal attachment between legs and rails so that the legs remain vertical irrespective of the angle to which the inclination is adjusted. In other embodiments, the side rails may take the form of elongate profiles shaped to support the rotatable rollers and prevent the core-trays from falling laterally from the track.

The angle of inclination ‘a’ of logging table 26 is adjustable for operator convenience by means of a manually settable adjustment mechanism, in which the distal supporting leg 48a has an upper section 58a defining a sleeve into which a lower, base section 58b slidingly is received. Angle may be as much as 45°. At greater angles, there is increasing risk of a core or other sample being dislodged from the tilted core tray. Each section has a row of alignable apertures 60 and a locking pin 62. When an aperture in moveable upper section 58a is brought into alignment with an aperture in grounded base section 58b, the locking pin may be inserted to penetrate both aligned apertures, preventing vertical relative travel between the upper and base sections, as suggested by directional arrow D5. Alternative means of height adjustment may be utilised without departing from the scope of this disclosure. These may, without limitation, include hydraulic or pneumatic positioning mechanisms, or mechanical rack and pinion-type devices, usually being electrically powered or adjustable by hand.

To span the gap in angle of inclination or orientation between the horizontal track 36 and logging table 26, track adapter section 60 is introduced. It has a first rail 64, which is horizontally aligned with rail 50b of logging table 26, and a second rail 66, which extends on an upward incline from a lower end 68, where it meets the horizontal rail of horizontal track section 36 (or a bridging piece 34), to an upper end 70, at which it meets the horizontal upper rail 50a of the track section of logging table 26. Rollers are mounted rotatably at each of their ends to the respective rails, as in the case of the rollers 52 of logging table 26. As the rails 64, 66 of adapter section 60 are not parallel, but change in relative elevation and angular orientation, the rollers 72 in section 60 change progressively in their orientation from end 68 to end 70 of rail 66. Adapter section 60 is configurable to achieve an adjustable angle of inclination of between 25° and 45° at its upper, most laterally inclined end 70. In a preferred embodiment, the angle of inclination at its inclined end 70 is in the range from 30° to 40°. The rollers together define an imaginary and continuously curving roller surface, over which the core tray passes in use for logging in the direction of directional arrow T.

When located adjacent to the to the track section of logging table 26, a continuous roller track is formed having changing gradient and camber, thereby allowing uninterrupted travel of a core tray from a horizontal orientation along a progressive gradient provided by the adapter section and on to the inclined roller track section of the logging table. The core tray is of sufficiently stiff construction to progress along the curving track surface while keeping the cores within intact. Without this arrangement of track sections, the core tray would have to be lifted from the horizontal section of the roller track, tilted and placed on the inclined track section of the logging table.

Because the rails 50a,b of logging table 26 are inclined away from the vertical, rails 64 and 66 of adapter section 60, which are straight, are not in exact alignment at each end with the rails which they meet. This is illustrated in the end view of FIG. 7(b) and results in the roller track of section 60 having successive rollers 72 that progressively become increasingly inclined and slope away from the horizontal the nearer they are located to the rollers 52 of logging table 26. Rollers 72 are shown with shading to differentiate them from rollers 52 in separate track sections 36 and 26. Broadly, the track defined by the rollers of the adapter ramp 60 can be thought of as approximating the shape of a portion of a helix. When viewed from either end of the adapter section, the roller track appears twisted, made up of a series of consecutive rollers each being increasingly inclined from one end of the adapter to the other and giving the adapter track a curving appearance.

As illustrated in FIG. 6, adapter section 60 is mounted on supporting leg units 74 of a generally H-shaped configuration, as in the case of leg units 48a,b of logging table 26. The legs are shown to be connected by a pair of crossbars 49. However, fewer or more crossbars may be included, depending on structural considerations, such as arising from the materials of construction of the frame. The legs of H-units 74 of adapter section 60 are adjustable in height, as in the case of the legs of logging table 26. The legs may be shared by adapter 60 and logging table 26. To enable maintenance of a vertical orientation of leg units 74, the upright leg portions are hingedly connected to rails 64, 66 to adapt them to angular change brought about by adjustment in logging table elevation.

The adapter section 60 includes fall guards on the lower side adjacent lower rail 64. These include right-angled brackets 76 that have an arm extending laterally outwardly from rail 64. Each has a side roller 78 mounted rotatably in the generally upwardly extending arm of the bracket. Apart from preventing the core tray from sliding off the rollers of adapter section 60, the rollers of the brackets provide rolling assistance for moving the core tray upward to the inclined plane of the logging table 26.

Because of the provision of the discrete rather than continuous nature of the fall guards defined by the brackets 76, the core-trays rolling along the imaginary curved surface defined by the successive pairs of rotatable rollers making up the track system do not slide continuously against lower side rail 64. Therefore, a discontinuity between successive side rails such as rails 64 and 50b can be tolerated. This allows for rail 64 to be used in straight, untwisted form without disrupting the continuity of the roller track over which the core-trays travel. In an alternative embodiment, however, rail 64 may be twisted so that its respective ends at 68 and 70 align seamlessly with the adjoining lateral rails of horizontal track section 30 and inclined logging table rail 50b. Similarly, opposite lateral rail 66 as it increases in elevation to meet upper rail 50a of logging table 26 need not be twisted, to align with rail 50a, as gravity will draw the core-tray away from the inner surface of the upper rail. However, in an embodiment, the rail 66 may be twisted into alignment with rail 50a if considered operatively appropriate. The rails of adapter section 60 may be connected to the rails with which they align using brackets and bolts 80, or other suitable fastenings. Alternatively, or additionally, adapter section 60 may be connected at its inclined end by virtue of sharing supporting legs 48a,b, which support logging table 26, and at its horizontally orientated end to legs 48 supporting horizontal track section 36, as illustrated in FIG. 3.

When the facility 10 is in operation, a flatbed truck 24 (partially truncated for illustrative purposes) reverses into receiving bay 14, loaded with one or more core trays (not shown). A core tray (not shown) is manually transferred from the truck bed to one of a plurality of waiting pallet lifters 42 having a supporting surface at the level of the truck bed. A human operator (not shown) causes the supporting surface of the lifter to be raised or lowered, as required, to the level of a tray-receiving station of a roller track conveying system.

Referring again to FIG. 2, it is seen that adapter sections 60 are provided at the terminal ends of the logging tables 26—that is to say at the ends closer to the dispatch bay 16. The adapter sections return the roller track to horizontal orientation, facilitating manual transfer of the logged core trays on to the lifting unit 42 for transfer to the forklift 28 and dispatch truck 32.

In a further embodiment (not illustrated), the adapter section 60 is configured for connecting to a horizontal first section 36 of roller track and an inclined section of roller track defining a logging table 26, wherein the horizontal section 36 is at an elevation which is higher than the level of the lower side of the logging table section. For example, the horizontal section may be located at chest height or even at about eye-level in some logging shed facilities. This may be done for further space saving considerations, which may include allowing for track over- and under-passes.

The adapter section of the present disclosure brings the advantage of a limited and known length of track being necessary for inclining a continuous assembly of track from the horizontal to up to 45° from the horizontal. This saves floor space in a logging facility and provides greater certainty in the planning of the layout of such facilities. It also ensures achievement of an ergonomically advantageous angle of inclination suitable for the comfort of personnel engaged in the task of core logging.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

In addition, use of the “a” or “an” are employed to describe elements and components of the embodiments herein. This is done merely for convenience and to give a general sense of the disclosure. This description should be read to include one, or at least one, and the singular also includes the plural, unless it is obvious that it is meant otherwise.

Upon reading this disclosure, those of skill in the art will appreciate still additional alternative structural and functional designs for a roller track inclination adapter and a process for transferring core trays to a logging table through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A method of establishing a continuous roller track leading from a first section of roller track to a second section of roller track, the first section being horizontally disposed and the second section being laterally inclined to define a logging table, the method including fitting between said sections a track inclination adapter comprising a length of roller track having a gradually changing lateral inclination that aligns at a first end with the horizontal first section and at an opposite second end with the laterally inclined second section, thereby to form a continuous roller track for travel of a core tray from the horizontal roller track section to the logging table.

2. The method of claim 1, wherein the adapter includes a pair of opposed spaced rails, between which a plurality of rollers is rotatably mounted to define a curve in said continuous roller track when viewed from the first or the second end.

3. The method of claim 2, wherein the curving roller track approximates a portion of a helix.

4. The method of claim 2, including adjusting the rails in height and angle relative to a horizontal plane.

5. A method of core tray logging including the steps of:
a. providing a logging table having a section of roller track orientated at an angle of lateral inclination for facilitating inspection and logging of drill cores in a core tray disposed on the table,
b. providing a track inclination adapter comprising a length of roller track having a gradually changing lateral inclination that at a first end is horizontally disposed, and, at an opposite second end, is laterally inclined for aligning with the section of roller track of the logging table, thereby to form a continuous roller track for travel of a core tray from the horizontal first end to the table,
c. operatively connecting the adapter first end to a section of horizontally disposed roller track and the adapter second end to the section of laterally inclined roller track of the logging table, and
d. propelling a core tray laden with drill cores along the track to the logging table and logging the cores.

6. The method of claim 5, wherein the adapter includes a pair of opposed rails, between which a plurality of rollers is rotatably mounted to define a curving roller track.

7. The method of claim 6, wherein the curving roller track approximates a portion of a helix.

8. A drill core logging table assembly including a core logging table having a section of laterally inclined roller track defining a plane on which a core tray is supportable for logging, and a roller track adapter comprising a section of roller track having a first end for aligning with the laterally inclined roller track of the table, and a second end that is horizontally disposed, configured for aligning with a horizontal roller track section, said roller track adapter section having a continuously and progressively increasing lateral inclination from end to end, whereby a continuous roller track is established for travel of a core tray from the horizontal track section to the table.

9. The assembly of claim 8, wherein the adapter includes a pair of opposed rails, between which a plurality of rollers is rotatably mounted to define a curving roller track when viewed end-on.

10. The assembly of claim 9, wherein the curving roller track approximates a portion of a helix.

11. An adapter configured for transitioning from a first roller track section having a horizontal orientation to a drill core logging table on which a second roller track section having a lateral inclination is mounted, so that a laden core tray is transferable by rolling it from the first section to the second, the adapter including a third roller track section having a first end for aligning with the first section and a second end for aligning with the second section, and being operably locatable between and connectable to said first and second sections, the third roller track section having a continuously and progressively increasing lateral inclination from end to end, thereby establishing a continuous roller track along which a core tray may travel from the first track section to the second section.

12. The adapter of claim 11, wherein the third roller track section has a shape approximating a part of a helix.

13. A drill core logging facility including a roller track system comprising a roller track that leads continuously from a receiving bay to an inspection station configured for inspection of drill cores in a core tray, wherein the track is configured to support a core tray in a horizontal first plane, and the inspection station is configured to support the tray in a second plane that differs from the first plane by being laterally inclined, wherein the roller track system includes an adapter section insertable to be installed intermediate the receiving bay and the inspection station, the adapter section transitioning the roller track from supporting a tray passing across it in the first plane to supporting it in the second plane, by virtue of including rollers having continuously and progressively changing lateral inclination from a first end of the adapter section coinciding with the first plane, to a second end coinciding with the second plane.

14. The facility of claim 13, wherein the second plane corresponds to a laterally inclined plane of the track at the inspection station, whereby visual inspection of drill cores on the core tray is facilitated.

15. The facility of claim 13, wherein the adapter section includes a pair of opposed rails, between which a plurality of rollers is rotatably mounted to define a curving roller track which approximates a portion of a helix.
